(19) United States
(12) Patent Application Publication
(10) Pub. No.: US 2016/0217355 A1
(43) Pub. Date: Jul. 28, 2016

(54) METHOD FOR CONTROLLING PRINTING APPARATUS, PRINTING APPARATUS, PRINTING MANAGEMENT SERVER, PRINTING SYSTEM, PRINTING CONTROL PROGRAM, AND RECORDING MEDIUM

(71) Applicant: SEIKO EPSON CORPORATION, Tokyo (JP)

(72) Inventor: Masahiko HIRASAWA, Sapporo-Shi (JP)

(73) Assignee: SEIKO EPSON CORPORATION, Tokyo (JP)

(21) Appl. No.: 14/995,737

(22) Filed: Jan. 14, 2016

(30) Foreign Application Priority Data
Jan. 22, 2015 (JP) 2015-010446

(51) Int. Cl. G06K 15/00; B41J 2/01; H04N 1/00

(52) U.S. Cl. CPC G06K 15/402; H04N 1/00344; B41J 2/01; H04N 2201/0072

(57) ABSTRACT

A method for controlling a printing apparatus includes detecting generation of an event by a printing apparatus that is capable of executing a plurality of operations including a printing operation, and selectively displaying an image indicating a candidate of a respondence operation to the event in a terminal apparatus, from a plurality of images indicating the operations which are capable of being displayed in the terminal apparatus, and are different from each other.

### BACKGROUND

1. Technical Field

The present invention relates to a technology that allows a user to grasp a respondence operation to an event which is generated by a printing apparatus.

2. Related Art

So far, there is a technology causing a printing apparatus to execute an operation which is indicated by a command, by transmitting the command to the printing apparatus from a portable terminal apparatus of a user. For example, it is conceivable that a handling button indicating the operation which is executed by the printing apparatus is displayed in a touch panel of the portable terminal apparatus. Therefore, if the user presses the handling button, the operation which is indicated by the handling button is executed by the printing apparatus.

Incidentally, in the printing apparatus, for example, various events such as a paper jam or a discharge fault of an ink may be generated. When such an event is generated, it is suitable that a respondence operation to the event is appropriately executed by the printing apparatus. Therefore, it is possible to easily grasp a candidate of the respondence operation to the generated event with the terminal apparatus, and it leads to an improvement in convenience of the user. However, the conceivable technique does not sufficiently answer the point.

### SUMMARY

An advantage of some aspects of the invention is to provide a technology that allows a user to easily grasp a candidate of a respondence operation to an event which is generated by a printing apparatus with a terminal apparatus.

According to an aspect of the invention, there is provided a method for controlling a printing apparatus including detecting generation of an event by a printing apparatus that is capable of executing a plurality of operations including a printing operation, and selectively displaying an image indicating a candidate of a respondence operation to the event in a terminal apparatus, from a plurality of images indicating the operations which are capable of being displayed in the terminal apparatus, and are different from each other.

According to an another aspect of the invention, there is provided a printing apparatus including a printing execution section that is capable of executing a plurality of operations including a printing operation, and a communication section that selectively displays an image indicating a candidate of a respondence operation to an event in a terminal apparatus, from a plurality of images indicating the operations which are capable of being displayed in the terminal apparatus, and are different from each other, by outputting a signal depending on the event which is generated by the printing execution section.

According to still another aspect of the invention, there is provided a printing management server including a control section that controls a printing apparatus which is capable of executing a plurality of operations including a printing operation, and a communication section that selectively displays an image indicating a candidate of a respondence operation to an event in a terminal apparatus, from a plurality of images indicating the operations which are capable of being displayed in the terminal apparatus, and are different from each other, by outputting a signal depending on the event which is generated by the printing apparatus.

According to still another aspect of the invention, there is provided a printing system including a printing apparatus that is capable of executing a plurality of operations including a printing operation, and a printing management server that selectively displays an image indicating a candidate of a respondence operation to an event in a terminal apparatus, from a plurality of images indicating the operations which are capable of being displayed in the terminal apparatus, and are different from each other, by outputting a signal depending on the event which is generated by the printing apparatus.

According to still another aspect of the invention, there is provided a printing control program causing a computer which is mounted in a terminal apparatus to execute selecting an image indicating a candidate of a respondence operation to an event that is generated by a printing apparatus which is capable of executing a plurality of operations including a printing operation, from a plurality of images indicating the operations which are capable of being displayed in the terminal apparatus, and are different from each other, and displaying the selected image in the terminal apparatus.

According to still another aspect of the invention, there is provided a recording medium that records the program described above to be read out by a computer.

In the aspects (the method for controlling a printing apparatus, the printing apparatus, the printing management server, the printing system, the program, and the recording medium) of the invention which are configured in this manner, the image indicating the candidate of the respondence operation to the event which is generated by the printing apparatus is displayed in the terminal apparatus. Moreover, the image is selectively displayed from the plurality of images which are capable of being displayed in the terminal apparatus. Therefore, it is possible to simplify the display of the terminal apparatus, by suppressing the display of the image which is unrelated to the responding to the event. As a result, the user can easily grasp the candidate of the respondence operation to the event which is generated by the printing apparatus with the terminal apparatus.

The method for controlling a printing apparatus, may be configured to include detecting whether a first handling is executed with respect to the image which is displayed in the terminal apparatus, and displaying a description of a respondence operation which is indicated by the image where the execution of the first handling is detected in the terminal apparatus. In the configuration, the user can accurately confirm a content of the respondence operation which is indicated by the image, by executing the first handling with respect to the image.

Moreover, the method for controlling a printing apparatus may be configured to include displaying a value of a parameter which is set in the printing apparatus, on a screen where the description is displayed, and transmitting a command for changing the value of the parameter depending on a handling (selection instruction or selection operation) of the screen to the printing apparatus. In the configuration, the user can appropriately change the value of the parameter which is set in the printing apparatus.

The method for controlling a printing apparatus may be configured to include detecting whether a second handling is executed with respect to the description which is displayed in the terminal apparatus, and transmitting a command for executing a respondence operation which is indicated by the description where the execution of the second handling is detected to the printing apparatus. In the configuration, the user can accurately execute the respondence operation by the printing apparatus, after confirming the content of the respondence operation which is indicated by the image.

The method for controlling a printing apparatus may be configured to include detecting whether a third handling is executed with respect to the image which is displayed in the terminal apparatus, and transmitting a command for executing a respondence operation which is indicated by the image where the execution of the third handling is detected to the printing apparatus. In the configuration, the user can accurately execute the respondence operation to the event by the printing apparatus, by executing the third handling with respect to the image which is selectively displayed.

The method for controlling a printing apparatus may be configured to include detecting whether a fourth handling is executed with respect to the image which is an execution target of the third handling, and transmitting a command for cancelling the command that is transmitted by the third handling which is executed with respect to the image where the execution of the fourth handling is detected to the printing apparatus. In the configuration, the user can easily cancel the command which is transmitted to the printing apparatus.

Moreover, the method for controlling a printing apparatus may be configured such that a display mode of the image which is a target of transmitting a command for executing a respondence operation, is changed before and after the transmitting. In the configuration, the user can easily grasp that the transmitting of the command is executed.

The method for controlling a printing apparatus may be configured to include displaying a transmission history that is obtained by arranging the images responding to the commands which are transmitted to the printing apparatus in sequence of the transmitted commands in the terminal apparatus. In the configuration, the user can easily grasp the transmission history of the commands.

The method for controlling a printing apparatus may be configured to include detecting whether a fifth handling is executed with respect to the image of the transmission history, and retransmitting a command responding to the image where the execution of the fifth handling is detected to the printing apparatus. In the configuration, the user can easily execute the retransmitting of the command from the transmission history, by executing the fifth handling.

Moreover, the method for controlling a printing apparatus may be configured such that a display mode of the image of the transmission history, varies depending on whether or not the retransmitting is performed. In the configuration, the user can easily grasp whether or not the retransmitting of the image of the transmission history is performed.

Additionally, the method for controlling a printing apparatus may be configured such that when the candidates of the respondence operations to the event are two or more, two or more images indicating the respondence operations which are different from each other are displayed in the terminal apparatus. In the configuration, since the candidates of two or more respondence operations are not displayed by characters, but are displayed by two or more images, it is possible to save a space which is necessary for the display, and it is possible to enhance glanceable ability of the user.

### BRIEF DESCRIPTION OF THE DRAWINGS

The invention will be described with reference to the accompanying drawings, wherein like numbers reference like elements.

FIG. 1 is a view illustrating configurations of a printing apparatus, a printing management server, and a terminal apparatus.

FIG. 2 is a view illustrating a catalogue of examples of stamps which are displayed in a display of the terminal apparatus.

FIG. 3 is a flowchart illustrating an example of a method for controlling the printing according to an embodiment.

FIG. 4 is a view illustrating an example of a list of stamps which are displayed depending on contents of events.

FIG. 5 is a view illustrating a display example of the terminal apparatus indicating generation of the event by the printing apparatus.

FIG. 6 is a view illustrating an example of a stamp description window which is displayed in the terminal apparatus.

FIG. 7 is a view illustrating a modification example of a display format of the display of the terminal apparatus.

FIG. 8 is a view illustrating a modification example of the display format of the display of the terminal apparatus.

FIG. 9 is a view illustrating a modification example of the display format of the display of the terminal apparatus.

FIG. 10 is a view illustrating a modification example of the display format of the display of the terminal apparatus.

### DESCRIPTION OF EXEMPLARY EMBODIMENTS

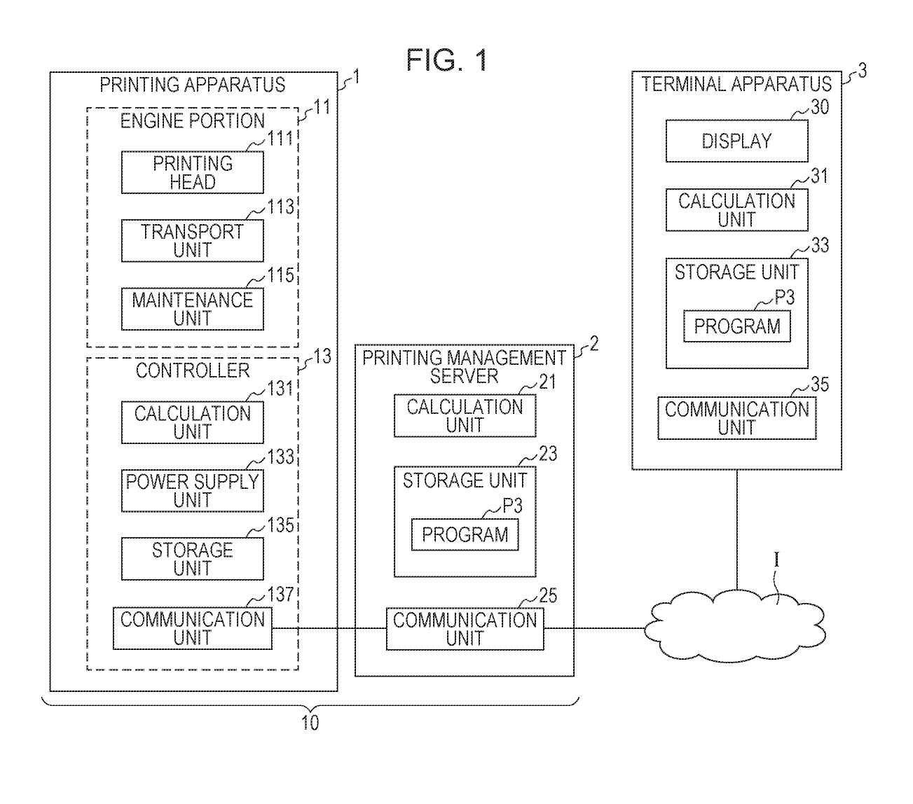

FIG. 1 is a view schematically illustrating configurations of a printing apparatus, a printing management server, and a terminal apparatus that are capable of executing a method for controlling the printing according to embodiments of the invention. In FIG. 1, the Internet I is written together, in addition to a printing apparatus 1, a printing management server 2, and a terminal apparatus 3. The printing apparatus 1, and the printing management server 2 configure a printing system 10, and are capable of communicating with each other through a local area network (LAN). Moreover, the printing management server 2, and the terminal apparatus 3 are capable of communicating with each other through the Internet I.

The printing apparatus 1 includes an engine portion 11 being a mechanical configuration of the printing apparatus 1, and a controller 13 being an electrical configuration of controlling the engine portion 11. The engine portion 11 of the printing apparatus 1, is a portion that performs the printing by discharging an ink to the paper (web). For example, the engine portion 11 includes the same configuration as the mechanical configuration of the printing apparatus which is illustrated in JP-A-2014-180805 or JP-A-2013-997.

The engine portion 11 includes a printing head 111, a transport unit 113, and a maintenance unit 115. The printing head 111 includes a plurality of nozzles, and prints a printing target onto the paper by discharging the ink to the paper which is at a predetermined printing position by an ink jet system from each nozzle. The transport unit 113 is a unit that transports the paper along a transport path, and supplies the paper before the printing to the printing position, and discharges the paper after the printing from the printing position. Moreover, the maintenance unit 115 executes a cleaning with respect to the printing head 111. The cleaning is an operation of forcibly discharging the ink from the nozzle, by applying a negative pressure to a cap in a state of covering the nozzle of the printing head 111 by the cap.

The controller 13 includes a calculation unit 131, a power supply unit 133, a storage unit 135, and a communication unit 137. The calculation unit 131 is configured by a central processing unit (CPU), a random access memory (RAM) or the like, and generally controls the operations of the printing apparatus 1. The power supply unit 133 is a circuit that controls a power supply of the printing apparatus 1, and executes a power supply-on and a power supply-off, or the power management. The storage unit 135 is a hard disk drive (HDD) that stores various types of programs or data. Moreover, the communication unit 137 is a communication interface that controls the communication with the outside, and is connected to the LAN between the printing apparatus 1 and the printing management server 2.

In the printing apparatus 1, a printing job which is received by the communication unit 137 from the printing management server 2, is stored in the storage unit 135. Therefore, the calculation unit 131 executes a rendering of converting the printing job into the printing data, and drives the printing head 111 on the basis of the printing data. Thereby, at the timing of the discharging which is indicated by the printing data, the ink is discharged from each nozzle of the printing head 111, and the printing target which is indicated by the printing job is printed onto the paper.

Incidentally, in the printing apparatus 1, various types of errors such as a failure of the rendering, generation of a paper jam, a nozzle miss, an error of a firmware or a software or an error of a hardware may be generated. Here, the failure of the rendering is an error of failing in the conversion of the printing job into the printing data. The generation of the paper jam is an error in which the middle of the transport path of the transport unit 113 is clogged with the paper. The nozzle miss is an error in which a proper amount of the ink may not be discharged from the nozzle of the printing head 111. The error of the firmware or the software is an error based on an operation fault of the controller 13, and for example, a freeze of the controller 13 or the like may be exemplified. The error of the hardware is an error based on the operation fault of the engine portion 11, and for example, a physical breakdown of the engine portion 11 may be exemplified. Therefore, the calculation unit 131 of the controller 13 carries out a function of appropriately monitoring presence or absence of the errors.

The printing management server 2 is a computer that manages the operation of the printing apparatus 1, and includes a calculation unit 21, a storage unit 23, and a communication unit 25. The calculation unit 21 is configured by the CPU, the RAM or the like, and generally controls the operation of the printing management server 2. The storage unit 23 is an HDD that stores various types of programs or data, and particularly stores a program P3 (application software) for the terminal apparatus 3. The communication unit 25 is a communication interface that controls the communication with the outside, and is connected to the LAN between the communication unit 137 of the printing apparatus 1 and the printing management server 2, and is connected to the Internet I. The printing management server 2 is capable of communicating with each of the printing apparatus 1 and the terminal apparatus 3 by the communication unit 25, and notifies the status of the printing apparatus 1 to the terminal apparatus 3, or notifies a command from the terminal apparatus 3 to the printing apparatus 1.

In the embodiments, the terminal apparatus 3 is a transportable type portable terminal apparatus (for example, a smart phone or a tablet) including a display 30 which is configured by a liquid crystal touch panel. The terminal apparatus 3 includes a calculation unit 31, a storage unit 33, and a communication unit 35. The calculation unit 31 is configured by the CPU, the RAM or the like, and generally controls the operation of the terminal apparatus 3. The storage unit 33 is an HDD that stores various types of programs or data, and stores the program P3 for the terminal apparatus 3 which is downloaded through the communication unit 35 from the printing management server 2. The communication unit 35 is a communication interface that controls the communication with the outside through the Internet I.

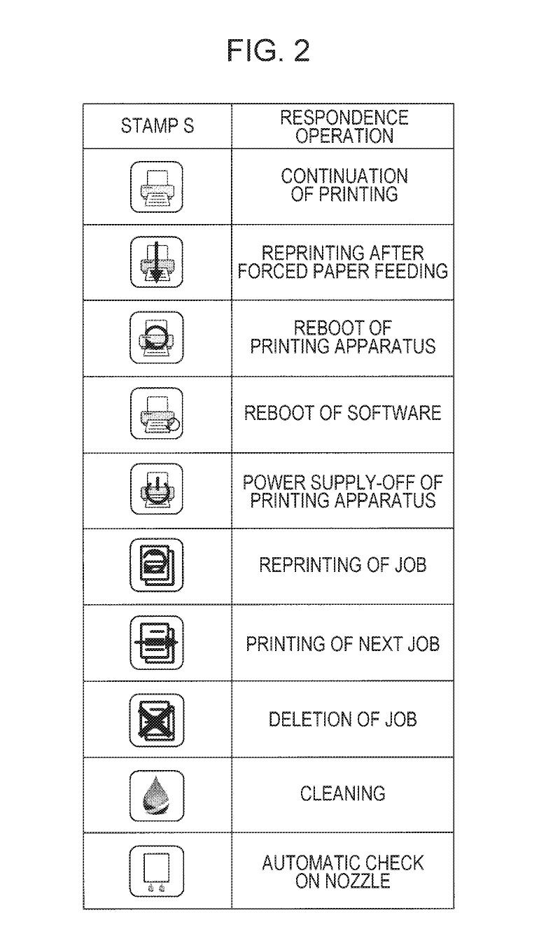

In the printing apparatus 1 described above, various types of events such as completion of the printing or the errors described above may be generated. When the event is generated, there is a need to execute a respondence operation depending on the event by the printing apparatus 1. Therefore, in the method for controlling the printing according to the embodiment, if the event is generated by the printing apparatus 1, a stamp S (FIG. 2) indicating a candidate of the respondence operation to the event is displayed in the display 30 of the terminal apparatus 3 of an user.

FIG. 2 is a view illustrating a catalogue of examples of the stamps which are displayed in the display of the terminal apparatus. As illustrated in FIG. 2, each stamp S expresses a content of the respondence operation by an image, and each of the stamps S indicating the respondence operations which are different from each other have the images which are different from each other. In the terminal apparatus 3, the image data of the stamp S is developed by the execution of the program P3 with the calculation unit 31, and is stored in the storage unit 33.

Here, a continuation of the printing is an operation of continuing with the printing during the execution or during the suspension. A reprinting after a forced paper feeding is an operation of performing the printing of the printing target onto the paper again, after the paper is forcibly transported in the middle of the transport path by the transport unit 113. A reboot of the printing apparatus is an operation of rebooting the engine portion 11 and the controller 13 of the printing apparatus 1. A reboot of the software is an operation of rebooting only the controller 13 of the printing apparatus 1. The power supply-off of the terminal apparatus 3 is an operation of turning off the power supply of the printing apparatus 1 by the power supply unit 133. A reprinting of the job is an operation of performing the printing by performing the rendering again with respect to the job in which the printing responding to the job is during the execution or during the suspension. The printing of the next job is an operation of performing the printing with respect to the next job of the job in which the printing responding to the job is during the execution or during the suspension (furthermore, the job in which the printing responding to the job is during the execution or during the suspension is deleted). A deletion of the job is an operation of deleting the job in which the printing responding to the job is during the execution or during the suspension. A cleaning is an operation of performing the cleaning of the printing head 111 by the maintenance unit 115. An automatic check on the nozzle is an operation of automatically and intermittently checking the presence or absence of the generation of the nozzle miss.

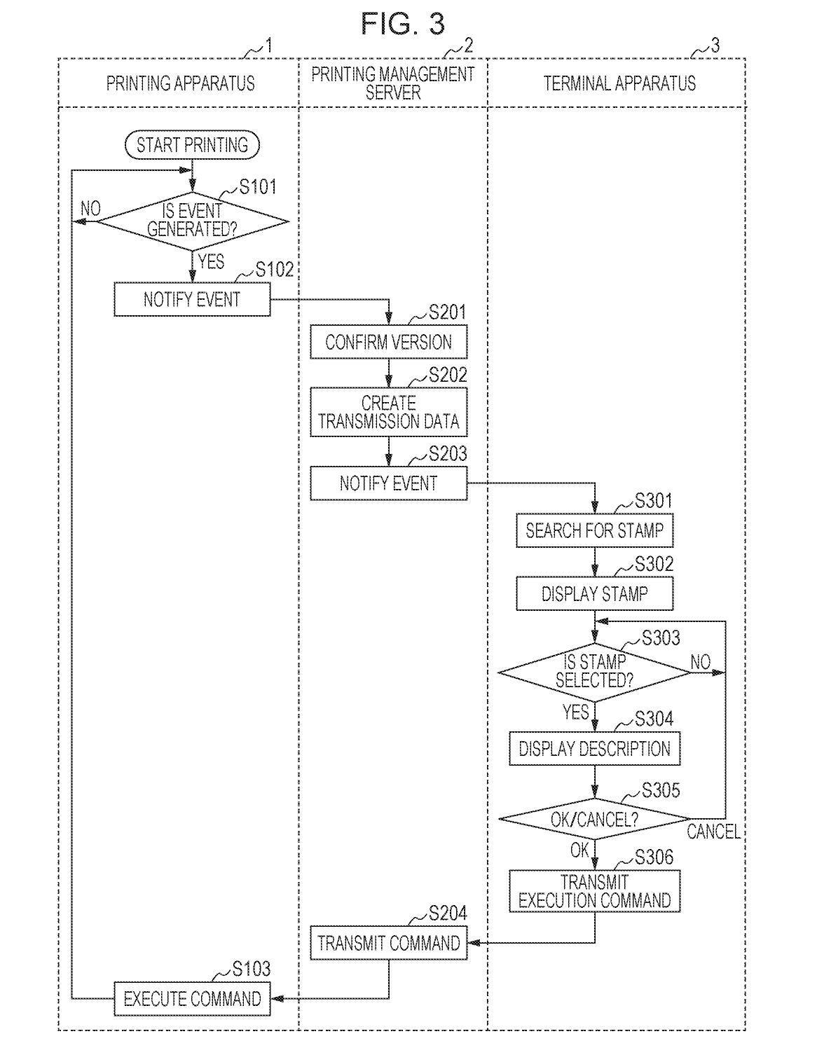

FIG. 3 is a flowchart illustrating an example of the method for controlling the printing according to the embodiment. In FIG. 3, in order to indicate whether each of steps of the flowchart are executed by any of the printing apparatus 1, the printing management server 2, and the terminal apparatus 3, each of the steps are written in a column indicating an execution subject thereof. Here, steps S101 to S103 which are indicated in the column of the printing apparatus 1, are executed by performing the calculation that is defined in the program for the printing apparatus 1 with the calculation unit 131 of the printing apparatus 1. Steps S201 to S204 which are indicated in the column of the printing management server 2, are executed by performing the calculation that is defined in the program for the printing management server 2 with the calculation unit 21 of the printing management server 2. Moreover, steps S301 to S306 which are indicated in the column of the terminal apparatus 3, are executed by performing the calculation that is defined in the program P3 for the terminal apparatus 3 with the calculation unit 31 of the terminal apparatus 3.

If a printing start command is received, the calculation unit 131 of the printing apparatus 1 starts a series of printing operations such as the rendering or the driving of the printing head 111, and starts the monitoring of the presence or absence of the generation of the event in the printing apparatus 1 (step S101). Therefore, if the generation of the event is confirmed (“YES” in step S101), the calculation unit 131 of the printing apparatus 1 notifies the event to the printing management server 2 (step S102).

The printing management server 2 which receives the event notification, confirms a version of the terminal apparatus 3 that becomes a transfer destination (step S201). That is, the terminal information indicating the terminal apparatus 3 which becomes the transfer destination of the event, is registered in the storage unit 23 of the printing management server 2. If the event notification is received, the printing management server 2 confirms the version of the program P3 which is installed in the terminal apparatus 3, by accessing the terminal apparatus 3 of the transfer destination on the basis of the terminal information. At this time, if the version of the program P3 of the terminal apparatus 3 agrees with the version of the program P3 which is stored in the printing management server 2, the process proceeds to step S202 as it is, and after a version-up of an old case is performed (that is, after the program P3 which is stored in the printing management server 2 is downloaded in the terminal apparatus 3), the process proceeds to step S202. By appropriately performing the version-up in this manner, the image data of the stamp S of the terminal apparatus 3 which becomes the transfer destination is updated.

In step S202, the calculation unit 21 is the printing management server 2 creates the transmission data indicating the content of the event which is generated by the printing apparatus 1. Therefore, the printing management server 2 performs the notification of the event to the terminal apparatus 3, by transmitting the transmission data to the terminal apparatus 3 (step S203).

The terminal apparatus 3 which receives the event notification, searches for the stamp S (that is, stamp S indicating the candidate of the respondence operation to the event) responding to the event that is indicated by the transmission data (step S301). Specifically, the calculation unit 31 confirms the event which is indicated by the transmission data by performing an analysis of the transmission data, and searches for the stamp S responding to the confirmed event from a plurality of stamps S (FIG. 2) which are stored in the storage unit 33. Therefore, the calculation unit 31 displays a search result in the display 30 (step S302). Thereby, the stamp S indicating the candidate of the respondence operation to the event which is generated by the printing apparatus 1 is selected from the plurality of stamps S illustrated in FIG. 2, and is displayed in the display 30 of the terminal apparatus 3.

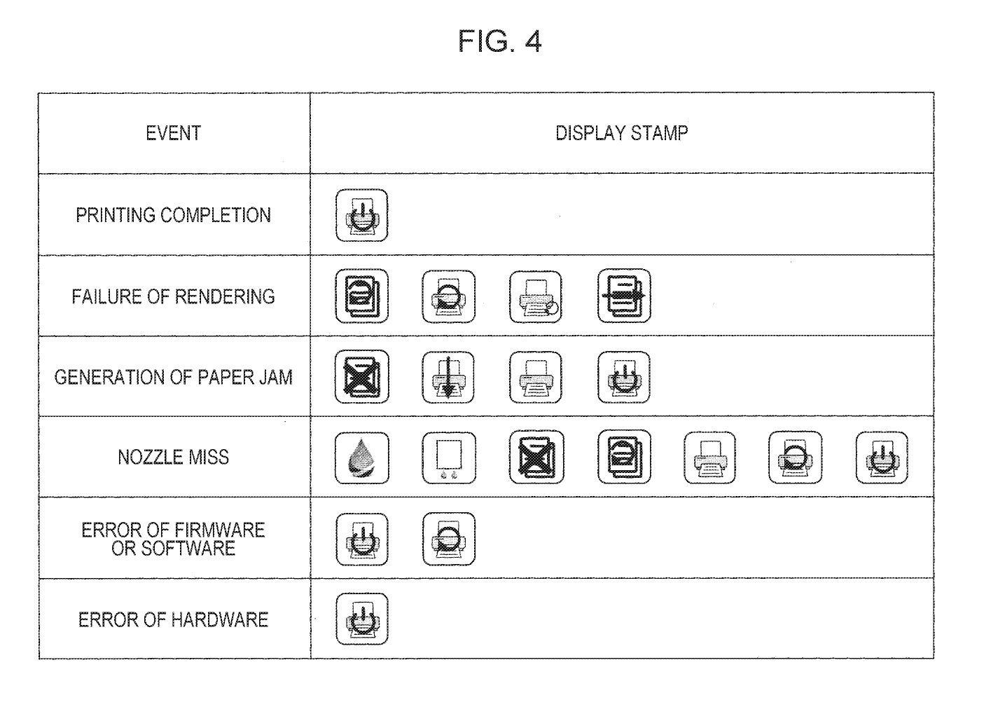

FIG. 4 is a view illustrating an example of a list of the stamps which are displayed depending on the contents of the events. As illustrated in FIG. 4, when the printing is completed, the stamp S indicating the power supply-off of the printing apparatus is displayed. When the failure of the rendering is generated, the stamps S indicating the reprinting of the job, the reboot of the printing apparatus, the reboot of the software, and the printing of the next job are respectively displayed. When the paper jam is generated, the stamps S indicating the deletion of the job, the reprinting after the forced paper feeding, the continuation of the printing, and the power supply-off of the printing apparatus are respectively displayed. When the nozzle miss is generated, the stamps S indicating the cleaning, the automatic check on the nozzle, the deletion of the job, the reprinting of the job, the continuation of the printing, the reboot of the printing apparatus, and the power supply-off of the printing apparatus are respectively displayed. When the error of the firmware or the software is generated, the stamps S indicating the power supply-off and the printing apparatus and the reboot of the printing apparatus are respectively displayed. When the error of the hardware is generated, the stamp S indicating the power supply-off of the printing apparatus is displayed.

That is, in the terminal apparatus 3, the calculation unit 31 executes the program P3, and thereby, the list data indicating the list of FIG. 4 is developed, and is stored in the storage unit 33. Therefore, the calculation unit 31 searches for the stamp S responding to the content of the event (step S301), by comparing the event which is indicated by the transmission data with the list which is indicated by the list data, and displays the search result in the display 30 (step S302). In this manner, the stamp S indicating the respondence operation depending on the content of the event is selected from the plurality of stamps S illustrated in FIG. 2, and is displayed in the display 30.

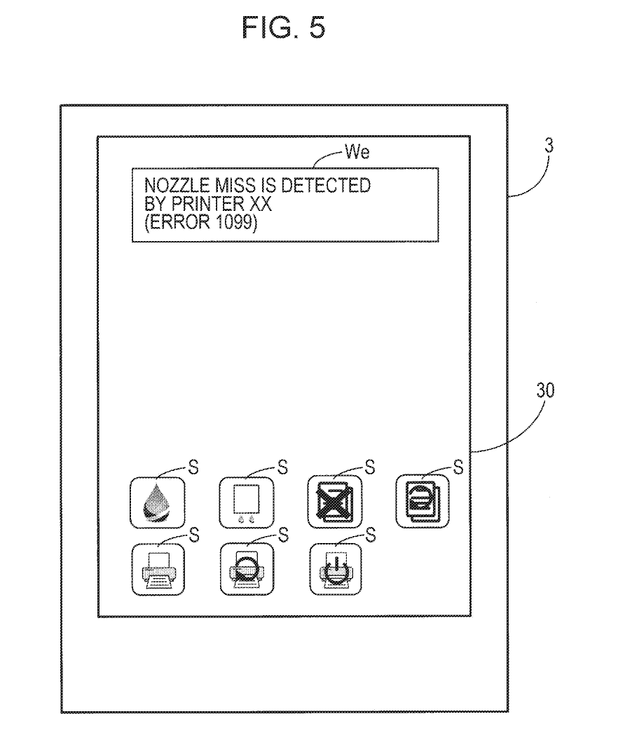

FIG. 5 is a view illustrating a display example of the terminal apparatus indicating the generation of the event by the printing apparatus. As illustrated in FIG. 5, in the display 30, an event notification window We indicating the content of the event which is generated by the printing apparatus 1 (printer) by characters, and each of the stamps S indicating the candidates of the respondence operation to the event which is indicated in the event notification window We are displayed together. Furthermore, in the event notification window We, an identification code (“XX” in FIG. 5) of the printing apparatus 1 where the event is generated, a character description (“nozzle miss” in FIG. 5) of the content of the event, and an event code (“error 1099” in FIG. 5) indicating the content of the event are displayed.

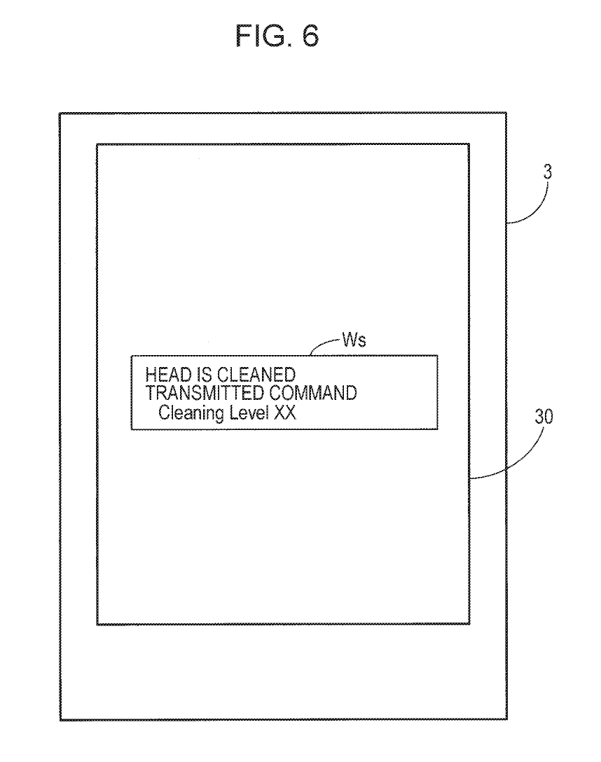

The description will continue along the flowchart of FIG. 3 while the example of FIG. 5 is used. In step S303, the calculation unit 31 monitors whether or not one stamp S among the stamps S which are displayed in the display 30 is selected by the user. Specifically, the calculation unit 31 recognizes a handling of the user who taps the stamp S in the display 30 as a selection handling. Here, the tapping indicates a handling of touching the target with a finger. Therefore, when the selection handling is executed (“YES” in step S303), a stamp description window Ws for describing the content of the stamp S which becomes an execution target of the selection handling is displayed in the display 30 (FIG. 6).

FIG. 6 is a view illustrating an example of the stamp description window which is displayed in the display of the terminal apparatus, and particularly illustrates an example of a case where the content of the stamp S responding to the cleaning is described. As illustrated in FIG. 6, the stamp description window Ws indicates the character description (“clean head” in FIG. 6) of the content of the stamp S, and a text (“Cleaning Level XX” in FIG. 6) of the command for executing the respondence operation which is indicated by the stamp S with the printing apparatus 1. By such the stamp description window Ws, the user can accurately grasp the content of the stamp S.

The description will continue along the flowchart of FIG. 3 while the examples of FIG. 5 and FIG. 6 are used. In step S305, the calculation unit 31 monitors the handling that is executed by the user with respect to the display 30 which displays the stamp description window Ws. Therefore, when the user executes a cancellation handling of tapping a portion other than the stamp description window Ws (“CANCEL” in step S305), the calculation unit 31 returns the display content of the display 30 to the state of FIG. 5, and the process returns to step S303. On the other hand, when the user executes a transmission handling of flicking the stamp description window Ws upwards (“OK” in step S305), the calculation unit 31 transmits the execution command for executing the respondence operation which is indicated by the stamp description window Ws with the printing apparatus 1 to the printing management server 2 (step S306). Here, the flicking indicates a handling of causing the finger to slide in a predetermined direction while to touch the target with the finger.

The printing management server 2 transfers the execution command which is received from the terminal apparatus 3 to the printing apparatus 1 (step S204). Incidentally, as described above, the printing management server 2 can perform the event notification with respect to a plurality of terminal apparatuses 3. Therefore, there is a case where each of the users who handle each of terminal apparatuses 3 transmit the execution commands to the printing management server 2, and the printing management server 2 receives an overlapping or unnecessary execution command. Accordingly, the printing management server 2 determines whether or not there is a need to transmit the execution command that is received from the printing management server 2 to the printing apparatus 1, on the basis of a result which is obtained by comparing the received execution command with the transmitted execution command. Therefore, only when there is the need, the execution command is transmitted to the printing apparatus 1. For example, when the execution command which is received from one terminal apparatus 3 overlaps with the execution command which is transmitted to the printing apparatus 1 by being received from another terminal apparatus 3, the printing management server 2 do not transmit the execution command which is received from one terminal apparatus 3 to the printing apparatus 1.

Accordingly, the printing apparatus 1 which receives the execution command from the printing management server 2 executes the respondence operation that is indicated by the execution command (step S103), and returns to step S101. In step S103, if the respondence operation is executed, the printing apparatus 1 transmits a reply notifying the purport to the terminal apparatus 3 through the printing management server 2.

As described above, in the embodiments, the stamp S indicating the candidate of the respondence operation to the event which is generated by the printing apparatus 1 is displayed in the terminal apparatus 3. Moreover, the stamp S is selectively displayed from the plurality of stamps S (FIG. 2) which are capable of being displayed in the terminal apparatus 3. Therefore, it is possible to simplify the display of the terminal apparatus 3, by suppressing the display of the stamp S which is unrelated to the responding to the event. As a result, the user can easily grasp the candidate of the respondence operation to the event which is generated by the printing apparatus 1 with the terminal apparatus 3.

Still more, if it is detected that the user executes the selection handling with respect to the stamp S (step S303), the terminal apparatus 3 displays the description of the respondence operation that is indicated by the stamp S which becomes the target of the selection handling (step S304). That is, the user can accurately confirm the content of the respondence operation which is indicated by the stamp S, by executing the selection handling with respect to the stamp S.

If it is detected that the user executes the transmission handling with respect to the event notification window We (step S305), the terminal apparatus 3 transmits the execution command for executing the respondence operation that is indicated by the event notification window We which becomes the target of the transmission handling to the printing apparatus 1 through the printing management server 2 (step S306). Therefore, the user can accurately execute the respondence operation by the printing apparatus 1, after confirming the content of the respondence operation which is indicated by the stamp S. Moreover, since the terminal apparatus 3 recognizes the flicking instead of the tapping as a transmission handling, even when the user is carelessly in contact with the display 30, it is suppressed that the execution command is transmitted by mistake.

Additionally, when the candidates of the respondence operations to the event are two or more, the terminal apparatus 3 displays two or more stamps S indicating the respondence operations which are different from each other. In the configuration, since the candidates of two or more respondence operations are not displayed by the characters, but are displayed by two or more stamps S, it is possible to save a space which is necessary for the display, and it is possible to enhance glanceable ability of the user.

In this manner, in the embodiments, the printing apparatus 1 is equivalent to an example of “printing apparatus” of the invention, the engine portion 11 is equivalent to an example of “printing execution section (of the printing apparatus)” of the invention, the communication unit 137 is equivalent to an example of “communication section (of the printing apparatus)” of the invention, the printing management server 2 is equivalent to an example of “printing management server” of the invention, the calculation unit 21 is equivalent to an example of “control section (of the printing management server)” of the invention, the communication unit 25 is equivalent to an example of “communication section (of the printing management server)” of the invention, the printing system 10 is equivalent to an example of “printing system” of the invention, the program P3 is equivalent to an example of “program” of the invention, the storage unit 23 or the storage unit 33 is equivalent to an example of “recording medium” of the invention, the calculation unit 31 is equivalent to an example of “computer” of the invention, the terminal apparatus 3 is equivalent to an example of “terminal apparatus” of the invention, the stamp S is equivalent to an example of “image” of the invention, the selection handling by step S303 is equivalent to an example of “first handling” of the invention, and the transmission handling by step S305 is equivalent to an example of “second handling” of the invention.

Furthermore, the present invention is not limited to the embodiments described above, and it is possible to add various modifications to the embodiments described above as long as without departing from the gist thereof. For example, in the embodiments described above, the transmission handling of transmitting the execution command of the respondence operation which is indicated by the stamp S to the printing apparatus 1, is executed by flicking the stamp description window Ws illustrated in FIG. 6. However, the terminal apparatus 3 may be configured such that the user confirms the transmitting of the execution command. Specifically, if the user taps the stamp description window Ws, the terminal apparatus 3 displays a transmission button for confirming whether or not the execution command which is indicated in the stamp description window Ws is transmitted to the printing apparatus 1 by the user in the display 30. Therefore, if the user taps the transmission button, the terminal apparatus 3 transmits the execution command to the printing apparatus 1. In the configuration, a series of handlings which are from the tapping of the stamp description window Ws to the tapping of the transmission button is equivalent to an example of “second handling” of the invention.

Alternatively, if the proficiency in stamp S is advanced, the confirming of the stamp description window Ws by the user is not always needed. Therefore, even when the stamp description window Ws is not displayed, it may be configured to be capable of executing the transmission handling. Specifically, in step S302, with respect to the stamp S which is displayed in the display 30 (FIG. 5), it is monitored that whether or not the user executes the transmission handling of flicking upwards. Therefore, when the transmission handling is executed, the process proceeds to step S306, and the execution command for executing the respondence operation that is indicated by the stamp S which becomes the target of the transmission handling with the printing apparatus 1, is transmitted to the printing apparatus 1 from the terminal apparatus 3. That is, the user can accurately execute the respondence operation to the event by the printing apparatus 1, by executing the transmission handling (third handling) with respect to the stamp S. Moreover, since the terminal apparatus 3 recognizes the flicking instead of the tapping as a transmission handling, even when the user is carelessly in contact with the display 30, it is suppressed that the execution command is transmitted by mistake.

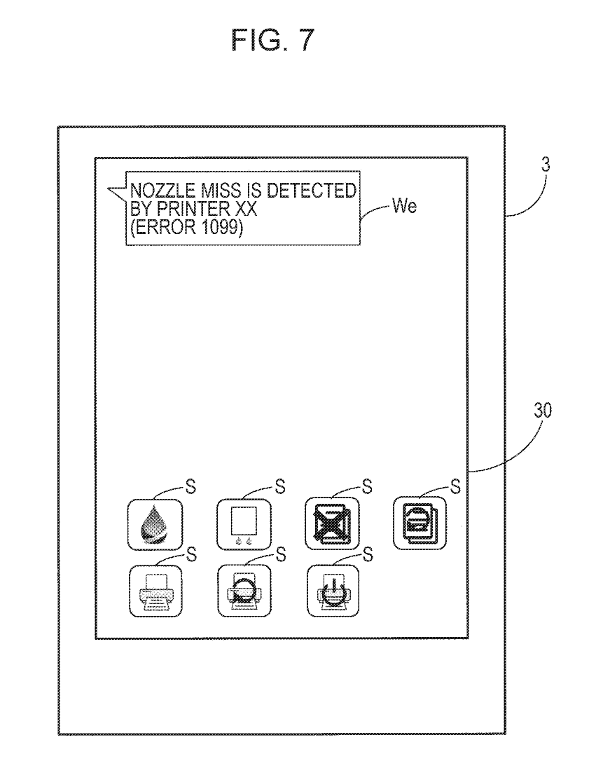

Additionally, as modification examples illustrated in FIG. 7 to FIG. 10, it may be configured such that a communication history of the event which is generated by the printing apparatus 1 and the command responding to the event is displayed in the display 30 of the terminal apparatus 3. Here, FIG. 7 to FIG. 10 are views illustrating modification examples of a display format of the display of the terminal apparatus, and the calculation unit 31 of the terminal apparatus 3 is executed by performing the calculation which is defined in the program P3. Here, points which are different from the embodiments described above will be mainly described, but it is needless to say that the same effects are achieved by including the configurations in common with the embodiments described above.

In the modification examples, the event notification window We indicating the event which is notified to the terminal apparatus 3 from the printing apparatus 1, and a transmitted command window Wc indicating the execution command which is transmitted to the printing apparatus 1 from the terminal apparatus 3 are displayed in the terminal apparatus 3 side by side in time series. In particular, the event notification window We and the transmitted command window Wc are displayed by the different shapes which are capable of being separated from each other. Specifically, the event notification window We has a shape which is moved to the left side while being blown out from the left side, and the transmitted command window Wc has a shape which is moved to the right side while being blown off from the right side.

If the event is generated by the printing apparatus 1, the terminal apparatus 3 which receives the event notification from the printing apparatus 1 displays the event notification window We notifying the event, and the stamp S indicating the candidate of the respondence operation to the event in the display 30 (FIG. 7). In the example of FIG. 7, a case where the nozzle miss is generated is illustrated. Moreover, the terminal apparatus 3 monitors whether or not the user executes the transmission handling of flicking upwards with respect to the stamp S which is displayed in the display 30, while displaying a screen of FIG. 7. Therefore, if the transmission handling is executed, the terminal apparatus 3 transmits the execution command for executing the respondence operation that is indicated by the stamp S which becomes the target of the transmission handling with the printing apparatus 1, to the printing apparatus 1.

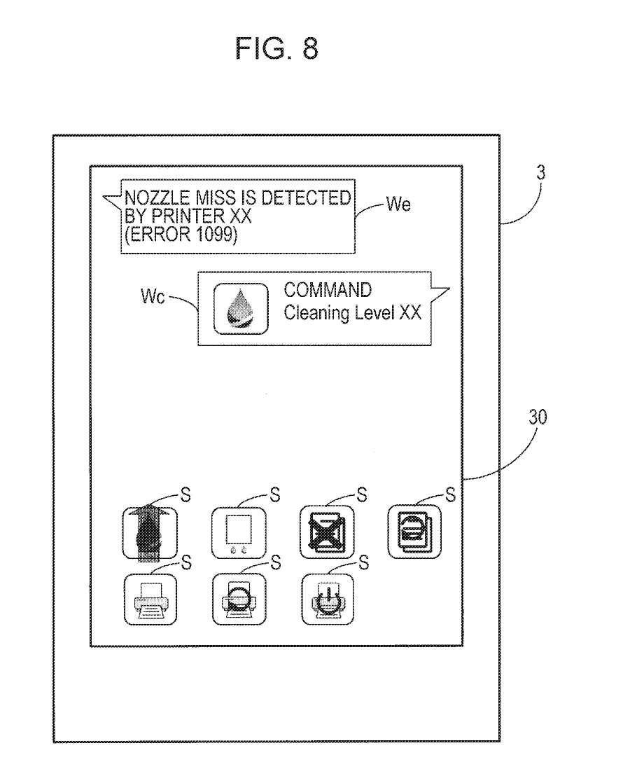

Along therewith, the terminal apparatus 3 displays the transmitted command window Wc indicating the content of the execution command which is transmitted to the printing apparatus 1 in the display 30 (FIG. 8). The transmitted command window Wc indicate the stamp S which becomes a transmission target of the execution command, and the text of the execution command. In the example of FIG. 8, a case where the execution command for executing the cleaning is transmitted, is illustrated.

As illustrated in FIG. 8, the terminal apparatus 3 changes a display mode of the stamp S which becomes the transmission target of the execution command, before and after the transmitting. Specifically, an arrow mark indicating the transmitted stamp is superimposed onto the stamp S after the transmitting by being compared with the stamp S before the transmitting. Thereby, the user can easily grasp that the transmitting of the execution command is executed. Incidentally, a specific method for changing the display mode of the stamp S before and after the transmitting, is not limited to the superimposing of the arrow mark, and for example, a method for changing the display mode of the stamp S after the transmitting into a transmission display may be used.

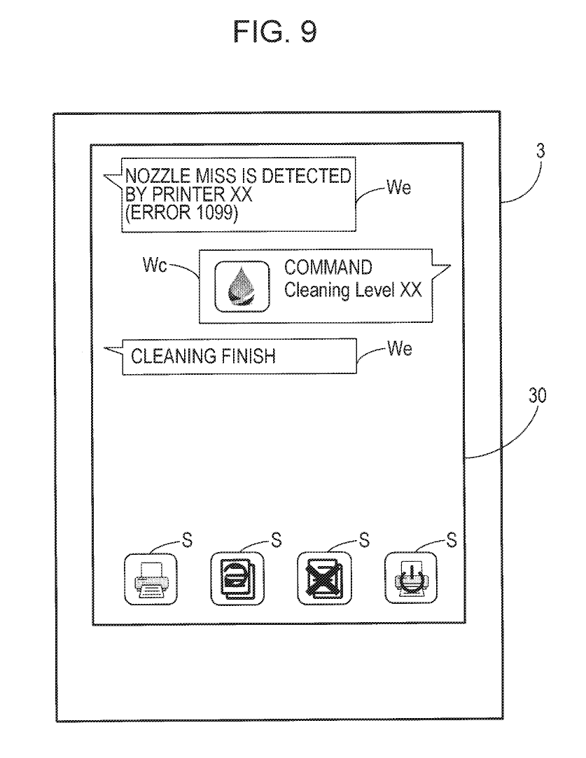

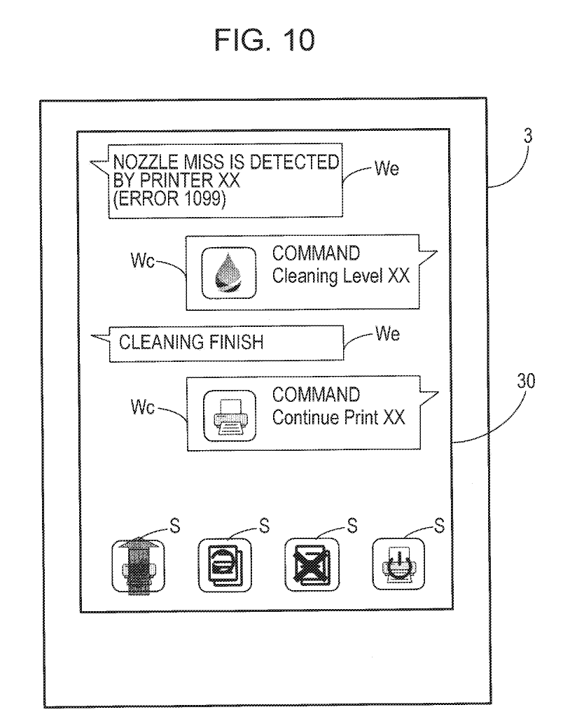

If the respondence operation (cleaning) which is indicated by the execution command is finished, the printing apparatus 1 transmits the event notification indicating the finish of the respondence operation to the terminal apparatus 3. The terminal 3 which has receives such the notification, displays the event notification window We and the stamp S in the display 30 in the same manner as described above (FIG. 9). Therefore, if the user executes the transmission handling, the terminal apparatus 3 transmits the execution command for executing the respondence operation that is indicated by the stamp S which becomes the target of the transmission handling with the printing apparatus 1, to the printing apparatus 1. Furthermore, the terminal apparatus 3 displays the transmitted command window We indicating the content of the transmitted execution command in the display 30, and changes the display mode of the stamp S which becomes the transmission target of the execution command before and after the transmitting (FIG. 10). In FIG. 10, a case where the execution command for executing the printing operation by the printing apparatus 1 is transmitted to the printing apparatus 1, is illustrated.

In the terminal apparatus 3, the communication history between the printing apparatus 1 and the terminal apparatus 3 (in other words, a reception history of the events, and a transmission history of the execution commands) is displayed along the time series. In the configuration, it is difficult to display all communication history in the display 30 at the same time, in accordance with the accumulation of the communication history. Therefore, the calculation unit 31 of the terminal apparatus 3 displays a portion of all communication history which is stored in the storage unit 33 in the display 30, and changes the portion which is displayed in the display 30 depending on a scroll handling of the user.

In this manner, in the modification examples illustrated in FIG. 7 to FIG. 10, the stamp S indicating the candidate of the respondence operation to the event which is generated by the printing apparatus 1, is displayed in the terminal apparatus 3. Moreover, the stamp S is selectively displayed from the plurality of stamps S (FIG. 2) which are capable of being displayed in the terminal apparatus 3. Therefore, it is possible to simplify the display of the terminal apparatus 3, by suppressing the display of the stamp S which is unrelated to the responding to the event. As a result, the user can easily grasp the candidate of the respondence operation to the event which is generated by the printing apparatus 1 with the terminal apparatus 3.

Additionally, the terminal apparatus 3 monitors whether or not the user executes the transmission handling of flicking upwards, with respect to the stamp S which is displayed in the display 30. Therefore, if the transmission handling is executed, the terminal apparatus 3 transmits the execution command for executing the respondence operation that is indicated by the stamp S which becomes the target of the transmission handling to the printing apparatus 1 through the printing management server 2. That is, the user can accurately execute the respondence operation to the event by the printing apparatus 1, by executing the transmission handling (third handling) with respect to the stamp S.

Moreover, the terminal apparatus 3 displays the communication history that is obtained by arranging the stamps S responding to the execution commands which are transmitted to the printing apparatus 1 in sequence of the transmitted execution commands in the display 30. Thereby, the user can easily grasp the communication history of the execution commands.

Also, it is possible to further add the change to the modification examples. For example, it may be configured to display the stamp description window Ws for describing the content of the stamp S, depending on a demand of the user. Specifically, the terminal apparatus 3 monitors whether or not the user executes the selection handling (selection) of tapping, with respect to the stamp S which is displayed in the display 30. Therefore, if the selection handling is executed, the terminal apparatus 3 displays the stamp description window Ws for describing the content of the stamp S which becomes the execution target of the selection handling as a pop-up window in the display 30. That is, the user can accurately confirm the content of the respondence operation which is indicated by the stamp S, by executing the selection handling (first handling) with respect to the stamp S.

Alternatively, it may be configured to be capable of retransmitting the execution command to the printing apparatus 1, by the handling of the user to the communication history which is displayed in the display 30. Specifically, the terminal apparatus 3 monitors whether or not the user executes a retransmission handling of flicking, with respect to the stamp S of the communication history which is displayed in the display 30. Therefore, if the retransmission handling is executed, the terminal apparatus 3 transmits the execution command for executing the respondence operation which is indicated by the stamp S which becomes the execution target of the retransmission handling with the printing apparatus 1 to the printing apparatus 1. In the configuration, the user can easily execute the retransmitting of the execution command from the communication history, by executing the retransmission handling (fifth handling).

Incidentally, there is an unsuitable case where a portion of the stamp S among the stamps S which are displayed in the communication history of the display 30 is retransmitted depending on the status of the printing apparatus 1. That is, as understood from the list of FIG. 4, for example, in the status where the error of the hardware is generated, it is not suitable to execute the operations other than the power supply-off by the printing apparatus 1. Therefore, the terminal apparatus 3 may be configured to control permission and prohibition of the retransmitting of the execution command per stamp S, depending on the status of the printing apparatus 1.

Specifically, the terminal apparatus 3 separates the execution commands responding to the printing apparatus 1 into the transmittable stamp S and the untransmittable stamp S, based on the content of the event which is most recently received. Then, the terminal apparatus 3 does not accept the retransmission handling with respect to the untransmittable stamp S. Thereby, it is possible to prevent the execution command which is unsuitable for the status of the printing apparatus 1 from being transmitted to the printing apparatus 1.

Furthermore, the terminal apparatus 3 varies depending on whether or not the display mode of the stamp S of the communication history of the display 30 is retransmitted. For example, the display of the stamp S in which the execution command responding to the stamp S is capable of being transmitted, may be displayed as it is, or may be modified such that an edge thereof is highlighted, the stamp S is displayed in large or the stamp S is displayed by superimposing an o mark onto the stamp S. Alternatively, the display of the stamp S in which the execution command responding to the stamp S is capable of being not transmitted, may be modified such that the stamp S is greyed out, the stamp S is displayed into the transmission display, the stamp S is displayed in small or the stamp S is displayed by superimposing an x mark onto the stamp S. Thereby, the user can easily grasp whether or not each of the stamps which are indicated in the communication history are retransmitted.

Furthermore, in the examples illustrated in FIG. 1 to FIG. 10, there is no problem where the terminal apparatus 3 is configured such that the user can cancel the transmitted execution command. For example, in the embodiments illustrated in FIG. 5 and FIG. 6, the terminal apparatus 3 displays a cancellation button for confirming whether or not the cancellation of the execution command is executed by the user, after the transmitting of the execution command. Therefore, if the user executes the cancellation handling of tapping the cancellation button (fourth handling), the terminal apparatus 3 transmits a cancellation command for cancelling the execution command to the printing apparatus 1.

Moreover, in the modification examples illustrated in FIG. 7 to FIG. 10, the terminal apparatus 3 monitors whether or not the user executes the cancellation handling (fourth handling) of flicking downwards, with respect to the stamp S onto which the arrow mark is superimposed. Therefore, if the user executes the cancellation handling, the terminal apparatus 3 transmits the cancellation command for cancelling the execution command that is indicated by the stamp S of the target to the printing apparatus 1. Incidentally, it is favorable that a direction (downward direction) of flicking in the cancellation handling, is different from a direction (upward direction) of flicking in the transmission handling or the retransmission handling.

In the configuration, the printing apparatus 1 which receives the cancellation command cancels the execution command, and stops the operation on the basis of the execution command. Accordingly, the user can easily cancel the execution command which is transmitted to the printing apparatus 1. In particular, if the case of the cancellation of the printing operation is used as an example, it is possible to reduce the burden on the user, at a point in which an operation of selecting the job of a cancellation target is not necessary, by starting up a window for displaying the catalogue of jobs which are transmitted to the printing apparatus 1, as the related art.

Moreover, it may be configured not only to transmit the execution command, but also to be capable of changing a value of a parameter which is set in the printing apparatus 1 from the terminal apparatus 3. For example, the value of the parameter such as the waiting time until the job is started, or the start time of the job may be displayed in the stamp description window Ws, and a command for changing the value of the parameter depending on the handling of the stamp description window Ws by the user may be transmitted to the printing apparatus 1 from the terminal apparatus 3. In the configuration, the user can appropriately change the value of the parameter which is set in the printing apparatus 1.

Still more, in the above description, the text data indicating the execution command is transmitted to the printing apparatus 1 from the terminal apparatus 3. However, the terminal apparatus 3 may be configured to transmit the image data of the stamp S indicating the execution command to the printing apparatus 1. In this case, the printing apparatus 1 may determine to the execution command responding to the image data by analyzing the image data, and may execute the respondence operation which is indicated by the execution command.

Additionally, a specific means of the communication between the printing apparatus 1 and the printing management server 2 is variously considered. Accordingly, for example, it is possible to perform the communication by using a short message service (SMS), a social networking service (SNS) or the like.

Moreover, the interposing of the printing management server 2 in the communication between the printing apparatus 1 and the terminal apparatus 3, is not always needed. Therefore, it may be configured to perform a direct communication between the printing apparatus 1 and the terminal apparatus 3.

In the above description, the terminal apparatus 3 is configured to recognize an input handling such as the tapping of the user or the flicking in the predetermined direction, as a selection handling, a transmission handling, a retransmission handling or a cancellation handling. However, it is only an example, and the terminal apparatus 3 may be configured to recognize the input handling of the user other than the above input handling as a selection handling, a transmission handling, a retransmission handling or a cancellation handling.

Moreover, in the above description, the case where the terminal apparatus 3 is configured by the smartphone or the tablet, is described. However, there is no problem that the terminal apparatus 3 is configured by a laptop personal computer. In this case, the terminal apparatus 3 may be configured to recognize the input handling by the user, to use one click responding to the above tapping, or to use double click responding to the above flicking. Alternatively, the terminal apparatus 3 may be configured to recognize the selection of a menu from right click as each handling by the user.

Furthermore, in the terminal apparatus 3, the event which is indicated by the received transmission data is confirmed, and the stamp S responding to the event that is confirmed from the plurality of stamps S which are stored in the storage unit 33 is displayed. However, the printing management server 2 or the printing apparatus 1 may store the stamp S, and the stamp S may be displayed in the terminal apparatus 3, by dealing with the terminal apparatus 3 as a browser. In this case, if the program of the printing management server 2 or the printing apparatus 1 is in the newest state, there is no need to confirm the version of the program P3 of the terminal apparatus 3, or to perform the version-up. Moreover, there is no need to confirm the event which is indicated by the transmission data with the terminal apparatus 3. When the handling is performed by the plurality of terminal apparatuses 3, it is easy to select the handling from any terminal apparatus 3, or to control the printing management server 2 or the printing apparatus 1.

The entire disclosure of Japanese Patent Application No.2015-010446, filed Jan. 22, 2015 is expressly incorporated by reference herein.

What is claimed is:

1. A method for controlling a printing apparatus, comprising:
detecting generation of an event by a printing apparatus that is capable of executing a plurality of operations including a printing operation; and
selectively displaying an image indicating a candidate of a respondence operation to the event in a terminal apparatus, from a plurality of images indicating the operations which are capable of being displayed in the terminal apparatus, and are different from each other.

2. The method for controlling a printing apparatus according to claim 1, further comprising:
detecting whether a first handling is executed with respect to the image which is displayed in the terminal apparatus; and
displaying a description of a respondence operation which is indicated by the image where the execution of the first handling is detected in the terminal apparatus.

3. The method for controlling a printing apparatus according to claim 2, further comprising:
displaying a value of a parameter which is set in the printing apparatus, on a screen where the description is displayed; and
transmitting a command for changing the value of the parameter depending on a handling of the screen to the printing apparatus.

4. The method for controlling a printing apparatus according to claim 2, further comprising:
detecting whether a second handling is executed with respect to the description which is displayed in the terminal apparatus; and
transmitting a command for executing a respondence operation which is indicated by the description where the execution of the second handling is detected to the printing apparatus.

5. The method for controlling a printing apparatus according to claim 1, further comprising:
detecting whether a third handling is executed with respect to the image which is displayed in the terminal apparatus; and
transmitting a command for executing a respondence operation which is indicated by the image where the execution of the third handling is detected to the printing apparatus.

6. The method for controlling a printing apparatus according to claim 5, further comprising:
detecting whether a fourth handling is executed with respect to the image which is an execution target of the third handling; and
transmitting a command for cancelling the command that is transmitted by the third handling which is executed with respect to the image where the execution of the fourth handling is detected to the printing apparatus.

7. The method for controlling a printing apparatus according to claim 5,
wherein a display mode of the image which is a target of transmitting a command for executing a respondence operation, is changed before and after the transmitting.

8. The method for controlling a printing apparatus according to claim 4, further comprising:
displaying a transmission history that is obtained by arranging the images responding to the commands which are transmitted to the printing apparatus in sequence of the transmitted commands in the terminal apparatus.

9. The method for controlling a printing apparatus according to claim 8, further comprising:
detecting whether a fifth handling is executed with respect to the image of the transmission history; and
retransmitting a command responding to the image where the execution of the fifth handling is detected to the printing apparatus.

10. The method for controlling a printing apparatus according to claim 9,
wherein a display mode of the image of the transmission history, varies depending on whether or not the retransmitting is performed.

11. The method for controlling a printing apparatus according to claim 1,
wherein when the candidates of the respondence operations to the event are two or more, two or more images indicating the respondence operations which are different from each other are displayed in the terminal apparatus.

12. A printing apparatus comprising:
a printing execution section that is capable of executing a plurality of operations including a printing operation; and
a communication section that selectively displays an image indicating a candidate of a respondence operation to an event in a terminal apparatus, from a plurality of images indicating the operations which are capable of being displayed in the terminal apparatus, and are different from each other, by outputting a signal depending on the event which is generated by the printing execution section.

13. A printing management server comprising:
a control section that controls a printing apparatus which is capable of executing a plurality of operations including a printing operation; and
a communication section that selectively displays an image indicating a candidate of a respondence operation to an event in a terminal apparatus, from a plurality of images indicating the operations which are capable of being displayed in the terminal apparatus, and are different from each other, by outputting a signal depending on the event which is generated by the printing apparatus.

14. A printing system comprising:
a printing apparatus that is capable of executing a plurality of operations including a printing operation; and
a printing management server that selectively displays an image indicating a candidate of a respondence operation to an event in a terminal apparatus, from a plurality of images indicating the operations which are capable of being displayed in the terminal apparatus, and are different from each other, by outputting a signal depending on the event which is generated by the printing apparatus.

15. A recording medium that records program according to be read out by a computer:
selecting an image indicating a candidate of a respondence operation to an event that is generated by a printing apparatus which is capable of executing a plurality of operations including a printing operation, from a plurality of images indicating the operations which are capable of being displayed in the terminal apparatus, and are different from each other; and
displaying the selected image in the terminal apparatus.
